(19) United States
(12) Patent Application Publication
(10) Pub. No.: US 2015/0202930 A1
(43) Pub. Date: Jul. 23, 2015

(54) AUTOMATIC TIRE INFLATION NOZZLE SYSTEM

(71) Applicants: Keun Jin JANG, Seoul (KR); Myung Han KIM, Changwon-si (KR)

(72) Inventor: Keun Jin Jang, Seoul (KR)

(21) Appl. No.: 14/533,881

(22) Filed: Nov. 5, 2014

(30) Foreign Application Priority Data
Jan. 23, 2014 (KR) 10-2014-0008574

(51) Int. Cl. B60C 23/00; B60C 29/06; B60C 29/02

(52) U.S. Cl. CPC B60C 23/00; B60C 29/02; B60C 29/06

(57) ABSTRACT

Provided is an automatic tire inflation nozzle and nozzle system. The nozzle includes: a nozzle body unit having an air outlet hole, an air inlet hole and an air pressure regulation hole; a first unidirectional air inlet unit combined with the air outlet hole to inject air from the nozzle body unit into the tire when the pressure inside the nozzle body unit is higher than the tire pressure; a second unidirectional air inlet unit combined with the air inlet hole to introduce atmospheric air into the nozzle body unit when the pressure inside the nozzle body unit is lower than the atmospheric pressure; an air pressure regulation unit combined with the air pressure regulation hole and having an adjusting member for regulating the tire pressure; and a piston installed in the nozzle body unit to reciprocate therein and having a piston rod partially protruding outside the nozzle body unit.

### CROSS-REFERENCE TO RELATED APPLICATIONS

This application claims the benefit of priority to Korean Patent Application No. 10-2014-0008574, filed Jan. 23, 2014, which is hereby incorporated by reference in its entirety into this application.

### BACKGROUND OF THE INVENTION

1. Field of the Invention

The present invention relates, in general, to a nozzle system for automatically inflating a tire of a vehicle and, more particularly, to an automatic tire inflation nozzle system that can continuously maintain the tire pressure at a preset pressure by operating a piston when the shape of a tire of a running vehicle is deformed due to contact of the tire with a ground surface.

2. Description of the Related Art

Generally, a central tire inflation system (hereinbelow, referred to simply as CTIS) is a device that can remote-control the air pressure inside at least one tire of a vehicle using a pressure source, such as an air brake compressor or a pressure storage tank installed in the vehicle, when the vehicle is stopped or runs on a ground surface. The CTIS can allow a driver to manually or automatically control the air pressure inside one or more tires in a remote-control manner when a vehicle, particularly, a truck, is stopped or is driven on a ground surface, so the tire pressure can be changed or maintained at a desired pressure.

A wheel valve used to inflate or deflate the tire of a wheel is typically installed on a rim or a hub of the wheel. The tire pressure may be increased or reduced by inflating or deflating the tire using the wheel valve. Here, the tire pressure is an important factor that can determine the comfort of passengers and power performance of vehicles.

FIG. 1 is a view illustrating the construction of a conventional CTIS used with an air tank installed in a lower part of a vehicle. In the CTIS, compressed air produced by an air compressor 110 is stored in an air tank 150 and is manually or automatically distributed and supplied via a manifold 140 under the control of a controller 120 in response to a vehicle speed detected by a speed sensor 130. Here, the CTIS supplies the compressed air to respective wheels 200 via respective wheel valves 100. The conventional CTIS is problematic in that a variety of parts, such as the air compressor 110, should be provided in the CTIS, thereby increasing the production and installation cost and the weight of the vehicle.

In an effort to overcome the above-mentioned problems, patent document 1 proposed an automatic tire inflation nozzle system that can automatically inflate a tire with air by actuating a pump when the tire is deformed and compressed due to contact with a ground surface during running of a vehicle. In the automatic tire inflation nozzle system, two pumps are installed in diametrically opposed circumferential positions of a wheel so as to inject air into a tire. This automatic tire inflation nozzle system is problematic in that two pumps should be installed in one wheel and may malfunction due to structural limits thereof. Further, the technique proposed in patent document 1 is configured to be exclusively operated only when the tire pressure is substantially reduced, so the nozzle system may fail to efficiently maintain the tire pressure at a predetermined constant level.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) Korean Patent Application Publication No. 10-2007-0040991 (Apr. 18, 2007)

### SUMMARY OF THE INVENTION

Accordingly, the present invention has been made keeping in mind the above problems occurring in the related art, and the present invention is intended to propose an automatic tire inflation nozzle and nozzle system that can maintain the tire pressure at a preset pressure by easily and simply replacing a conventional tire valve of a wheel with an automatic tire inflation nozzle system, without using a complicated air pressure supply device, such as an air tank or an air compressor.

In order to achieve the above object, according to one aspect of the present invention, there is provided an automatic tire inflation nozzle installed on a vehicle wheel so as to automatically inflate a tire with atmospheric air, the automatic tire inflation nozzle including: a nozzle body unit provided with an air outlet hole, an air inlet hole and an air pressure regulation hole; a first unidirectional air inlet unit combined with the air outlet hole and functioning to inject compressed air from the nozzle body unit into the tire when an air pressure inside the nozzle body unit is higher than a tire pressure; a second unidirectional air inlet unit combined with the air inlet hole and functioning to introduce atmospheric air into the nozzle body unit when the air pressure inside the nozzle body unit is lower than a pressure of the atmospheric air; an air pressure regulation unit combined with the air pressure regulation hole and provided with an adjusting member functioning to regulate the tire pressure; and a piston installed in the nozzle body unit so as to reciprocate within the nozzle body unit, the piston being provided with a piston rod partially protruding outside the nozzle body unit.

Each of the first unidirectional air inlet unit and the second unidirectional air inlet unit may include: a first housing having a front air passing hole in a front wall thereof and a rear air passing hole in a sidewall or a rear wall thereof; and a first T-shaped stopper installed in the first housing, wherein the first T-shaped stopper is provided with both a head having a size completely covering the front air passing hole and a shank opposed to the head and having a size smaller than the size of the head.

The automatic tire inflation nozzle may further include: a second biasing member placed between the first T-shaped stopper and an inner surface of the first housing. Here, the first T-shaped stopper may pressurize the first unidirectional air inlet unit under a constant pressure.

The first unidirectional air inlet unit may be combined with the air outlet hole in such a way that the front air passing hole faces an interior of the nozzle body unit, and the second unidirectional air inlet unit may be combined with the air inlet hole in such a way that the front air passing hole faces the atmosphere.

The air pressure regulation unit may include: a second housing provided with a front air inlet hole in a front wall thereof and a rear air passing hole in a sidewall or a rear wall thereof; a second T-shaped stopper installed in the second housing, the second T-shaped stopper being provided with both a head having a size completely covering the front air inlet hole and a shank opposed to the head and having a size smaller than the size of the head; and an adjusting member provided to protrude outside a rear surface of the second housing and functioning to adjust a pressure applied to the head of the second T-shaped stopper.

The air pressure regulation unit may include: a second housing having a front air inlet hole in a front wall thereof and a rear air passing hole in a sidewall or a rear wall thereof; a second T-shaped stopper installed in the second housing, the second T-shaped stopper being provided with both a head having a size completely covering the front air inlet hole and a shank opposed to the head and having a size smaller than the size of the head; and an adjusting member provided so as to protrude outside a rear surface of the second housing and functioning to adjust a pressure applied to the head of the second T-shaped stopper.

Here, a third biasing member may be placed between the adjusting member and the second T-shaped stopper so as to provide a biasing force.

The adjusting member may include: an adjusting knob; a lead screw provided on a first end of the adjusting knob; and a square nut engaged with an outer surface of the lead screw. In this case, a third biasing member may be placed between the square nut and the second T-shaped stopper.

In another aspect of the present invention, there is provided an automatic tire inflation nozzle system, including: the automatic tire inflation nozzle disclosed above; a connection rod having a first end combined with the piston rod protruding outside the nozzle body unit; and a tire contact part combined with a second end of the connection rod and being in contact with an inner surface of the tire.

As described above, the automatic tire inflation nozzle and nozzle system of the present invention can maintain the tire pressure at a preset pressure by easily and simply replacing a conventional tire valve of a wheel with the automatic tire inflation nozzle system, without using a complicated air pressure supply device, such as an air tank or an air compressor. Due to the simple construction of the nozzle system, this nozzle system is advantageous in that it may be easily and simply installed in a wheel at a tire shop or an auto repair shop equipped with a tire replacement system.

Further, the automatic tire inflation nozzle system of the present invention has a small volume and is light, so the nozzle system can maintain the tire pressure at a preset pressure without increasing the weight of a vehicle, thereby increasing the mileage of the vehicle. From the viewpoint of fuel efficiency, to increase mileage by 1 km/1 l, it is estimated that an investment of about four hundred million dollars into a car manufacturing company would be required. Thus, automatic tire inflation nozzle system of this invention can realize great economic effect because it can maintain vehicle tire pressure at a preset pressure, thus conveniently and inexpensively increasing vehicle fuel efficiency.

Additional aspects and/or advantages of the invention will be set forth in part in the description which follows and, in part, will be obvious from the description, or may be learned by practice of the invention.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view illustrating the construction of a conventional CTIS used with an air tank installed in a lower part of a vehicle;

FIGS. 2A and 2B are views illustrating the operation of an automatic tire inflation nozzle system according to the present invention installed on a wheel;

FIGS. 3A and 3B are sectional views of an automatic tire inflation nozzle system according to an embodiment of the present invention;

FIG. 4 is a sectional view of a unidirectional air inlet unit installed in the automatic tire inflation nozzle system according to an embodiment of the present invention;

FIGS. 5A to 5C are sectional views and a perspective view of an air pressure regulation unit installed in the automatic tire inflation nozzle system according to an embodiment of the present invention;

FIGS. 6A and 6B are sectional views of an air pressure regulation unit installed in the automatic tire inflation nozzle system according to another embodiment of the present invention;

FIG. 7 is a sectional view of a piston and a piston control rod installed in the automatic tire inflation nozzle system according to an embodiment of the present invention; and

FIGS. 8A to 8D are views illustrating the operation of the automatic tire inflation nozzle system according to the present invention.

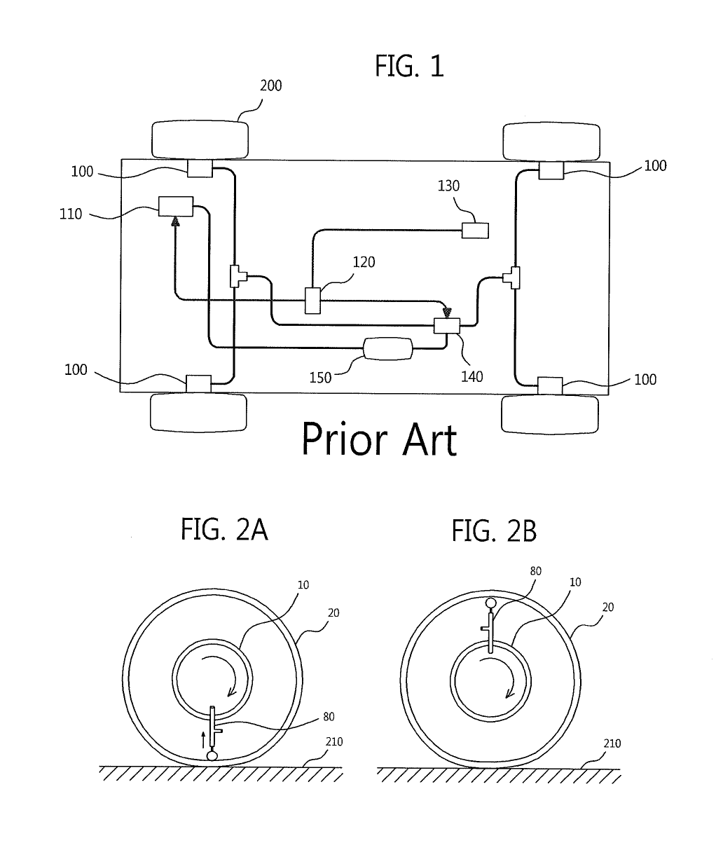

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinbelow, exemplary embodiments of the present invention will be described in detail with reference to the accompanying drawings.

FIGS. 2A and 2B are views illustrating the operation of an automatic tire inflation nozzle system according to the present invention installed in a wheel of a vehicle. The automatic tire inflation nozzle system according to the present invention is installed in a vehicle wheel 10 at a predetermined location that may be occupied by a conventional tire valve in the wheel 10. When a vehicle runs on a ground surface 210 at a high speed, the tire 20 is deformed at a part where the tire comes into contact with the surface 210, so the distance between the nozzle system and the ground surface 210 is reduced. The present invention was invented based on the reduction in the distance between the nozzle system and the ground surface. In other words, when a part of the wheel in which the automatic tire inflation nozzle system 80 is installed reaches a position at which the nozzle system 80 vertically faces the ground surface 210 during rotations of the wheel, a piston of the nozzle system is operated to inject air into the tire 20.

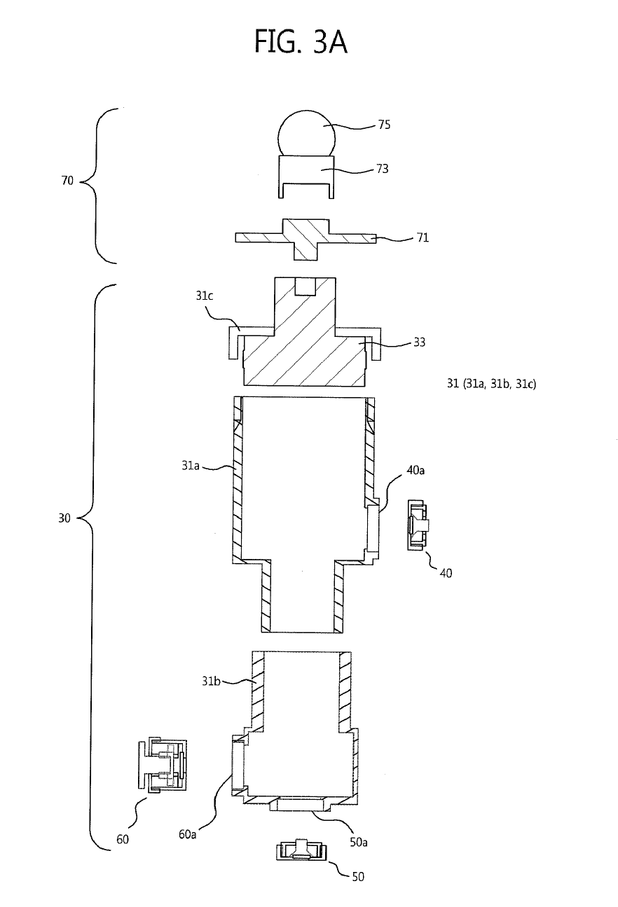

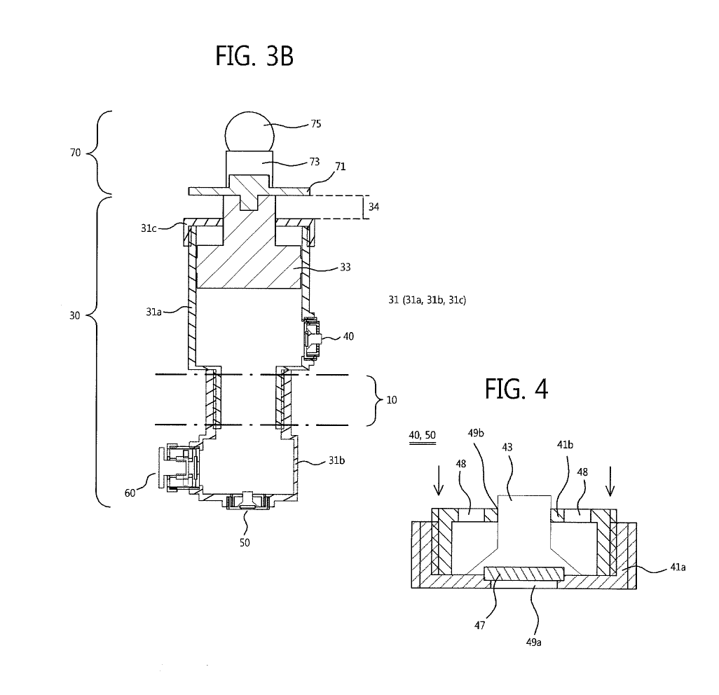

FIGS. 3A and 3B are sectional views of an automatic tire inflation nozzle system according to an embodiment of the present invention. The automatic tire inflation nozzle system of this invention includes an automatic tire inflation nozzle 30 having a piston therein, with a unidirectional air inlet unit and an air pressure regulation unit provided in the nozzle 30. The automatic tire inflation nozzle system further includes a piston actuator 70 that actuates the piston when the piston actuator 70 comes into contact with the tire during rotations of the tire. Here, FIG. 3A is a sectional view illustrating the nozzle system before a first unidirectional air inlet unit 40, a second unidirectional air inlet unit 50 and an air pressure regulation unit 60 are respectively set in an air outlet hole 40a, an air inlet hole 50a and an air pressure regulation hole 60a of the nozzle 30. FIG. 3B is a sectional view illustrating the nozzle system after the units 40, 50 and 60 are set in the respective holes 40a, 50a and 60a. Here, the automatic tire inflation nozzle 30 of the nozzle system is mounted to the wheel 10 and functions to inject air into the tire. When the automatic tire inflation nozzle 30 is mounted to the wheel 10, the air outlet hole 40a is positioned inside the tire and both the air inlet hole 50a and the air pressure regulation hole 60a are positioned outside the tire. The automatic tire inflation nozzle 30 of the nozzle system includes: a nozzle body unit 31 comprising nozzle bodies 31a, 31b and 31c, into or from which air flows through the air outlet hole 40a, the air inlet hole 50a and the air pressure regulation hole 60a; the first unidirectional air inlet unit 40 set in the air outlet hole 40a and functioning to supply compressed air from the nozzle bodies 31a, 31b and 31c into the tire; the second unidirectional air inlet unit 50 set in the air inlet hole 50A and functioning to supply atmospheric air into the nozzle bodies 31a, 31b and 31c; the air pressure regulation unit 60 set in the air pressure regulation hole 60a and functioning to discharge a part of compressed air from the nozzle bodies 31a, 31b and 31c into the atmosphere when the pressure of the compressed air is increased to a level higher than a predetermined level, so that the air pressure regulation unit 60 can maintain the tire pressure at a preset pressure; and a piston 33 that has a piston rod protruding outside the nozzle bodies 31a, 31b and 31c, and performs a reciprocation inside the nozzle bodies 31a, 31b and 31c. The piston actuator 70 of the nozzle system includes: a piston control rod 71 that is coupled to the piston rod of the piston 33 and provides a spring holding protrusion for holding a spring (not shown) functioning to provide a biasing force so as to restore the piston 33; a connection rod 73 connected to the piston control rod 71; and a tire contact part 75 provided on an end of the connection rod 73 and comes into contact with the inner surface of the tire during rotations of the tire. Here, a first biasing member (not shown, for example, a spring) may be placed between an end of the nozzle body unit 31 c and the piston control rod 71.

The air outlet hole 40a, the air inlet hole 50a and the air pressure regulation hole 60a of the nozzle body unit 31 are provided with respective internal threads, and the first unidirectional air inlet unit 40, the second unidirectional air inlet unit 50 and the air pressure regulation unit 60 set in the respective holes 40a, 50a and 60a of the nozzle body unit 31 are provided with respective external threads, so the units 40, 50 and 60 can be airtightly set in the respective holes 40a, 50a and 60a by a screw-type engagement method. Of course, it should be understood that another conventional engagement method, such as a one-touch engagement method, may be used instead of the screw-type engagement method if the engagement method can realize an airtight engagement between the units 40, 50 and 60 and the respective holes 40a, 50a and 60a. The first biasing member is a member that can provide a restoring force so as to elastically return the position of the piston 33 to an original position when the tire contact part 75 is released from the contact with the inner surface of the tire.

Further, although a spring is used as an example of the biasing member in the embodiment of the present invention, another structure, such as a pneumatic cylinder or a hydraulic cylinder, may be used instead of the spring if the structure can provide a restoring force.

Hereinbelow, the construction of the tire contact part 75 will be described in detail. As shown in FIG. 2A, the tire contact part 75 is a part that comes into contact with the inner surface of the tire 20 and pushes the piston 33 when a part of the wheel in which the nozzle system 80 is installed reaches a position at which the nozzle system 80 vertically faces the ground surface 210 during rotations of the wheel. Here, because the tire contact part 75 is the part that comes into contact with the inner surface of the tire 20, the tire contact part 75 may be made of a material having a hardness equal to or lower than the hardness of the inner surface of the tire 20 so as to avoid abrasion of the inner surface of the tire. Further, the connection rod 73 is a part that connects the tire contact part 75 to the piston control rod 71. In the present invention, the piston control rod 71 may be configured to have a fixed length, and the connection rod 73 may be configured to selectively use several sizes having various lengths suitable so that a connection rod 73 can be easily applied to a tire according to various models of tires. In other words, the sizes of the wheels and the models of the tires used in vehicles may be different from each other, so the distance between the piston of the automatic tire inflation nozzle 30 and the inner surface of the tire in FIG. 2A may be changed according to the sizes of the wheels and the models of the tires. Thus, to effectively use the nozzle system of the present invention in different wheels and different tires, the piston control rod 71 and the connection rod 73 are configured as described above. In the present invention, the piston rod, the piston control rod 71 and the connection rod 73 that constitute the piston actuator 70 may be combined with each other in various manners, so the configuration of the piston actuator 70 may be variously changed. For example, the connection rod 73 may be directly connected to the piston rod without using the piston control rod 71. In this case, the first biasing member (not shown) is placed between the end of the nozzle body 31 c and the connection rod 73.

The nozzle body unit 31 includes: a main body 31a receiving the piston 33 therein; a lower body 31c holding the piston 33 so as to prevent the piston 33 from being removed outside the nozzle body unit 31; and an exposed body 31 b exposed outside the tire. Here, the junction between the main body 31a and the exposed body 31b is configured to be narrower than the other part of the main body 31a, so, when the nozzle system is installed in the wheel 10, the nozzle system is firmly held in the wheel 10 without being easily removed from the wheel 10.

FIG. 4 is a sectional view of a unidirectional air inlet unit installed in the automatic tire inflation nozzle system according to an embodiment of the present invention. As shown in FIG. 4, two unidirectional air inlet units having the same configuration are installed in the nozzle body unit 31 in such a way that the two unidirectional air inlet units face opposite directions, so the two unidirectional air inlet units function as a first unidirectional air inlet unit 40 and a second unidirectional air inlet unit 50, respectively. In other words, to form the first unidirectional air inlet unit 40, a unidirectional air inlet unit is installed in the nozzle body unit 31 in such a way that a front air passing hole 49a of the unidirectional air inlet unit faces inwards as shown in FIGS. 3A and 3B. However, to form the second unidirectional air inlet unit 50, a unidirectional air inlet unit having the same construction as that of the first unidirectional air inlet unit 40 is installed in the nozzle body unit 31 in such a way that the front air passing hole 49a of the unidirectional air inlet unit faces outwards as shown in FIGS. 3A and 3B.

Each of the unidirectional air inlet units 40 and 50 includes: a first housing 41a having the front air passing hole 49a; a second housing 41 b having a guide hole 49b through which the shank of a first T-shaped stopper 43 reciprocates and rear air passing holes 48 through which air passes; the first T-shaped stopper 43 installed in the unidirectional air inlet unit 40, 50 formed by the first and second housings 41a and 41b combined with each other by a screw-type engagement; and a second biasing member (not shown) installed in the shank of the first T-shaped stopper 43. Here, the head of the first T-shaped stopper 43 has a size completely covering the front air passing hole 49a, and the shank of the first T-shaped stopper 43 opposed to the head has a size smaller than the size of the head. Further, a first gasket 47 is installed between the front air passing hole 49a of the first housing 41a and the end surface of the head of the first T-shaped stopper 43. Here, the first gasket 47 is mounted to the end surface of the head of the first T-shaped stopper 43 and may be made of a rubber material (for example, EPDM).

When the pressure applied from the outside to the front air passing hole 49a of the unidirectional air inlet unit 40, 50 is not higher than the inner pressure of the unidirectional air inlet unit 40, 50, the head of the first T-shaped stopper 43 and the first gasket 47 close the front air passing hole 49a due to the biasing force of the second biasing member, so air cannot pass through the front air passing hole 49a. However, when the pressure applied from the outside to the front air passing hole 49a of the unidirectional air inlet unit 40, 50 is increased to be higher than the inner pressure of the unidirectional air inlet unit 40, 50, the second biasing member is compressed and the first T-shaped stopper 43 is moved upwards in FIG. 4, so air flows into the unidirectional air inlet unit 40, 50 via the front air passing hole 49a and flows to the rear air passing holes 48 through the interior of the first and second housing 41a and 41b.

The above-mentioned construction of the unidirectional air inlet unit 40, 50 may be changed without affecting the functioning of the present invention. For example, the construction of the unidirectional air inlet unit 40, 50 may be changed if the front air passing hole 49a is formed in the front surface of the unidirectional air inlet unit, the rear air passing holes are formed in the side or rear surface of the unidirectional air inlet unit, and the front air passing hole 49a is configured to be closed at pressures lower than a predetermined level and opened at pressures higher than the predetermined level to allow air to pass through the front air passing hole 49a.

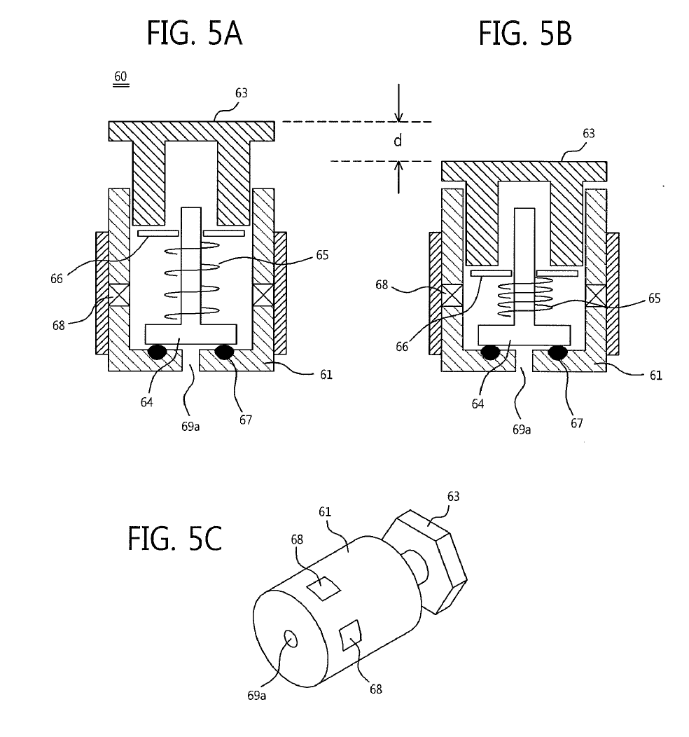

FIGS. 5A to 5C are views of an air pressure regulation unit installed in the automatic tire inflation nozzle system according to an embodiment of the present invention, in which FIG. 5A is a sectional view of the air pressure regulation unit regulated to be operated at a low pressure, FIG. 5B is a sectional view of the air pressure regulation unit regulated to be operated at a high pressure, and FIG. 5C is a perspective view of the air pressure regulation unit.

The air pressure regulation unit 60 includes: a second housing 61 having a front air inlet hole 69a formed in the front part, a rear opening formed in the rear part to receive an adjusting member 63 therein, and side air passing holes 68 formed through the sidewall to discharge air to the outside; a second T-shaped stopper 64 installed in a space defined between the interior of the second housing 61 and the adjusting member 63; a third biasing member 65 fitted over the shank of the second T-shaped stopper 64; and a washer 66 placed between the third biasing member 65 and the adjusting member 63. An O-ring 67 is installed on the inner surface of the second housing 61 having the front air inlet hole 69a, so, when the head of the second T-shaped stopper 64 is biased forward by the third biasing member 65, the O-ring 67 closes the front air inlet hole 69a. Here, the horizontal part of the second T-shaped stopper 64 in FIGS. 5A to 5C is referred to as a head and the vertical part of the second T-shaped stopper 64 is referred to as a shank. In the second T-shaped stopper 64, the head has a size completely covering the front air inlet hole 69a and the shank opposed to the head has a size smaller than the size of the head.

The adjusting member 63 is a part allowing a user to manually and externally adjust the pressure applied to the third biasing member 65. In the embodiment shown in FIGS. 5A to 5C, internal threads are formed on the inner surface of the sidewall of the second housing 61, and external threads are formed on the outer surface of the adjusting member 63, so a user can adjust the engagement strength between the adjusting member 63 and the second housing 61 by manipulating the exposed height adjusting member 63 by hand or using a tool, such as a driver or a wrench. In other words, when the adjusting member 63 is loosely combined with the second housing 61 as shown in FIG. 5A, the pressure applied to the third biasing member 65 is reduced, so that the head of the second T-shaped stopper 64 is spaced apart from the O-ring 67 although the pressure applied from the outside to the front air inlet hole 69a is low (for example, 25 psi). Thus, air flows into the second housing 61 and is discharged to the outside via the side air passing holes 68. However, when the adjusting member 63 is further fastened to the second housing 61 such that the height of the air pressure regulation unit 60 is reduced by the distance d as shown FIG. 5B, the pressure applied to the third biasing member 65 is increased, so that the head of the second T-shaped stopper 64 is spaced apart from the O-ring 67 and air flows into the second housing 61 and is discharged to the outside via the side air passing holes 68 only when a high pressure (for example, 35 psi) is applied from the outside to the front air inlet hole 69a. In other words, the adjusting member 63 is a part that can control the inlet air pressure of the front air inlet hole 69a by adjusting the elasticity of the second biasing member 65.

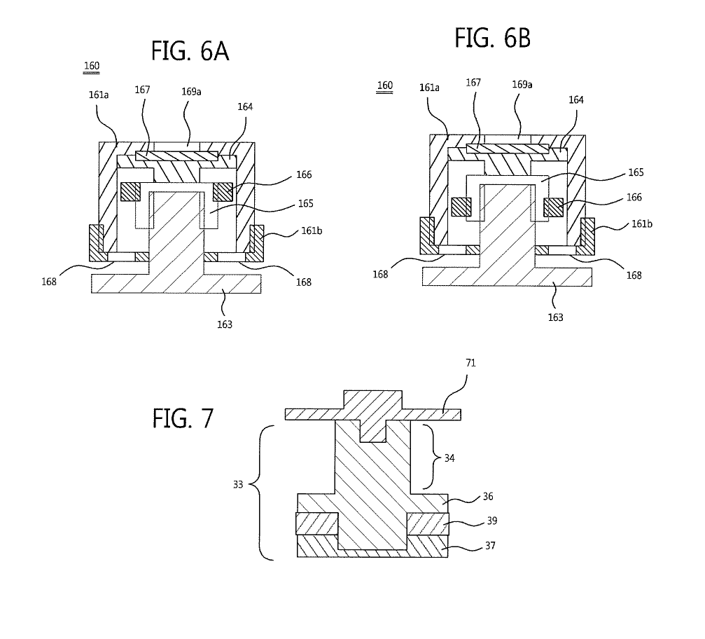

FIGS. 6A and 6B are sectional views of an air pressure regulation unit installed in the automatic tire inflation nozzle according to another embodiment of the present invention. As shown in the drawings, the air pressure regulation unit 60 includes: a first housing 161a having a front air inlet hole 169a formed in the front surface and an opening formed in the rear part; a second housing 161 b having rear air passing holes 168 formed in left and right sides and a central hole form in the center to receive an adjusting knob 163; a third T-shaped stopper 164 installed in the first and second housings 161a and 161b combined with each other; a lead screw 165 installed in the first and second housings 161a and 161b to be in contact with the shank of the third T-shaped stopper 164; a square nut 166 engaged with the lead screw 165 to move upward and downward in response to a rotation of the lead screw 165; a third biasing member (not shown) installed in a space between the third T-shaped stopper 164 and the square nut 166; the adjusting knob 163 rotating the lead screw 165; and a second gasket 167 installed between the first housing 161a having the front air inlet hole 169a and the end surface of the head of the third T-shaped stopper 164. Here, the second gasket 167 is mounted to the end surface of the head of the third T-shaped stopper 164 and may be made of a rubber material (for example, EPDM).

Here, the adjusting member is a part allowing a user to manually and externally adjust the pressure applied to the third biasing member. In the embodiment shown in FIGS. 6A and 6B, the adjusting member is formed by both the lead screw 165 engaged with the adjusting knob 163 and the square nut 166 engaged with the lead screw 165 and is configured to adjust the pressure applied to both the third T-shaped stopper 164 and the square nut 166. As shown in FIG. 6B, when the adjusting knob 163 is rotated, the square nut 166 moves downward along the lead screw 165 while being in contact with the inner surface of the first housing 161a. Thus, pressure is applied to the third biasing member installed between the square nut 166 and the third T-shaped stopper 164, so the tire pressure may be set to a low level. Here, the square nut 166 may be a nut having a polygonal shape, such as rectangular, pentagonal or hexagonal shape.

FIG. 7 is a sectional view of a piston and a piston control rod installed in the automatic tire inflation nozzle according to an embodiment of the present invention. As shown in the drawing, the piston 33 includes: a piston rod 36 having a cross-shaped section, with a piston control rod 71 combined with the lower end of the piston rod 36; a piston ring 39 fitted over the head of the piston rod 36; and a piston ring holder 37 tightened to the head of the piston rod 36 protruding outside the piston ring 39. Here, the first biasing member that is not shown in FIG. 7 is fitted over the piston rod 36 within a space 34 defined between the piston control rod 71 and the piston rod 36. The construction of the piston 33 shown in FIG. 7 may be changed without affecting the functioning of the present invention if the piston rod can partially protrude outside the nozzle bodies 31a, 31b and 31c and can compress air inside the nozzle bodies 31a, 31b and 31c.

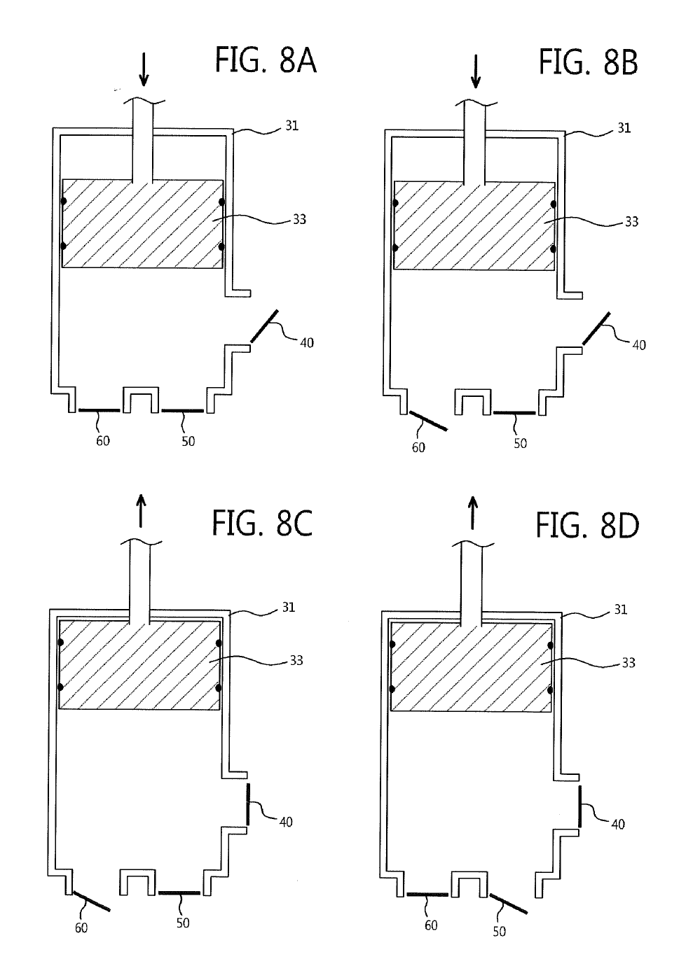

Hereinbelow, the operation of the automatic tire inflation nozzle system according to the present invention will be described with reference to FIGS. 8A to 8D. For ease of description, in FIGS. 8A to 8D, the first unidirectional air inlet unit 40, the second unidirectional air inlet unit 50 and the air pressure regulation unit 60 are shown in the form of simple switches. Further, it is assumed that the inner pressure of the tire is set to 34 psi and the air pressure regulation unit 60 is set to 36 psi in an initial stage of the nozzle system. That is, it is assumed that the automatic tire inflation nozzle system of this invention is operated under the condition that a driver sets the tire pressure to be maintained at 36 psi and the present tire pressure is lower than the preset pressure of the tire by 2 psi because the vehicle is not driven for a lengthy period of time.

In an initial stage of the nozzle system in which no pressure is applied to the piston 33 of the automatic tire inflation nozzle 30 as shown in FIG. 2B, all the first unidirectional air inlet unit 40, the second unidirectional air inlet unit 50 and the air pressure regulation unit 60 are maintained in closed states. When the vehicle operation is started from the above-mentioned state, the nozzle system repeatedly performs operations of “Injection of compressed air into tire”, “Suction of atmospheric air into nozzle”, and “Equilibrium”.

1. Injection of Compressed Air into Tire

When the vehicle starts to run and the nozzle system reaches a position shown in FIG. 2A in which a pressure is applied from the tire to the piston 33, the piston 33 moves upward and compresses air inside the nozzle body unit. When the pressure of the compressed air is equal to or exceeds 34 psi during the compression of air, the first unidirectional air inlet unit 40 is opened while both the second unidirectional air inlet unit 50 and the air pressure regulation unit 60 are maintained in closed states, so the nozzle system injects compressed air into the tire (see FIG. 8A).

2. Suction of Atmospheric Air into Nozzle

When the tire rolls on the ground surface so the nozzle system reaches the position of FIG. 2B in which no pressure is applied to the piston 33, the piston 33 stops the upward movement and moves downward to an original position thereof by the elasticity of the first biasing member, as shown in FIG. 8D. During the downward movement of the piston 33, the first unidirectional air inlet unit 40 is closed and the air-charged volume inside the nozzle body unit is increased while the amount of air charged in the nozzle body unit is maintained constant, so the air pressure inside the nozzle body unit is reduced. When the air pressure inside the nozzle body unit is reduced as described above, the second unidirectional air inlet unit 50 is opened while both the first unidirectional air inlet unit 40 and the air pressure regulation unit 60 are maintained in closed states, so atmospheric air is introduced into the nozzle body unit (see FIG. 8D).

When the vehicle runs continuously, the nozzle system repeatedly performs the operations of “Injection of compressed air into tire” and “Suction of atmospheric air into nozzle”, and the tire pressure is gradually increased. When the tire pressure reaches the preset pressure, 36 psi, due to the repeated operations of “Injection of compressed air into tire” and “Suction of atmospheric air into nozzle”, the nozzle system performs the operation of “Equilibrium”, as follows.

3. Equilibrium

When the vehicle continues the running after the tire pressure reaches the preset pressure, the piston 33 is pressurized by the tire, so the piston 33 moves upward and compresses the air inside the nozzle body unit. When the pressure of the compressed air is equal to or exceeds 36 psi during the compression of air, the air pressure regulation unit 60 is opened before the first unidirectional air inlet unit 40 is opened while the second unidirectional air inlet unit 50 is maintained in the closed state, as shown in FIG. 8C. Thus, the compressed air is discharged from the nozzle body unit to the atmosphere via the air pressure regulation unit 60, so the nozzle system can realize the state of “Equilibrium” in which the tire pressure is not further increased, but is maintained at an equilibrium level.

Strictly described, in an initial stage of the equilibrium state, there may be a transition stage in which the first unidirectional air inlet unit 40 is opened as shown in FIG. 8B and the compressed air inside the nozzle body unit is partially injected into the tire via the first unidirectional air inlet unit 40, and the air pressure regulation unit 60 is opened as shown in FIG. 8C and the compressed air inside the nozzle body unit is partially discharged to the atmosphere via the air pressure regulation unit 60. However, the transition stage is terminated within a short period of time, so the transition stage may be negligible.

The automatic tire inflation nozzle system according to the present invention is a part that is installed in a vehicle wheel, so it is required to make the nozzle system using a durable material that can efficiently resist various weather conditions and a variety of chemicals including chlorine. Here, to realize the desired durability of the automatic tire inflation nozzle system of the present invention, the elements may be made of aluminum and may be treated through anodizing.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An automatic tire inflation nozzle installed on a vehicle wheel so as to automatically inflate a tire with atmospheric air, the automatic tire inflation nozzle comprising:
a nozzle body unit provided with an air outlet hole, an air inlet hole and an air pressure regulation hole;
a first unidirectional air inlet unit combined with the air outlet hole and functioning to inject compressed air from the nozzle body unit into the tire when an air pressure inside the nozzle body unit is higher than a tire pressure;
a second unidirectional air inlet unit combined with the air inlet hole and functioning to introduce atmospheric air into the nozzle body unit when the air pressure inside the nozzle body unit is lower than a pressure of the atmospheric air;
an air pressure regulation unit combined with the air pressure regulation hole and provided with an adjusting member functioning to regulate the tire pressure; and
a piston installed in the nozzle body unit so as to reciprocate within the nozzle body unit, the piston being provided with a piston rod partially protruding outside the nozzle body unit.

2. The automatic tire inflation nozzle of claim 1, wherein each of the first unidirectional air inlet unit and the second unidirectional air inlet unit comprises:
a first housing having a front air passing hole in a front wall thereof and a rear air passing hole in a sidewall or a rear wall thereof; and
a first T-shaped stopper installed in the first housing, wherein the first T-shaped stopper is provided with both a head having a size completely covering the front air passing hole and a shank opposed to the head and having a size smaller than the size of the head.

3. The automatic tire inflation nozzle of claim 2, further comprising:
a second biasing member placed between the first T-shaped stopper and an inner surface of the first housing.

4. The automatic tire inflation nozzle of claim 2, wherein the first unidirectional air inlet unit is combined with the air outlet hole in such a way that the front air passing hole faces an interior of the nozzle body unit; and
the second unidirectional air inlet unit is combined with the air inlet hole in such a way that the front air passing hole faces the atmosphere.

5. The automatic tire inflation nozzle of claim 1, wherein the air pressure regulation unit comprises:
a second housing provided with a front air inlet hole in a front wall thereof and a rear air passing hole in a sidewall or a rear wall thereof;
a second T-shaped stopper installed in the second housing, the second T-shaped stopper being provided with both a head having a size completely covering the front air inlet hole and a shank opposed to the head and having a size smaller than the size of the head; and
an adjusting member provided to protrude outside a rear surface of the second housing and functioning to adjust a pressure applied to the head of the second T-shaped stopper.

6. The automatic tire inflation nozzle of claim 2, wherein the air pressure regulation unit comprises:
a second housing having a front air inlet hole in a front wall thereof and a rear air passing hole in a sidewall or a rear wall thereof;
a second T-shaped stopper installed in the second housing, the second T-shaped stopper being provided with both a head having a size completely covering the front air inlet hole and a shank opposed to the head and having a size smaller than the size of the head; and
an adjusting member provided so as to protrude outside a rear surface of the second housing and functioning to adjust a pressure applied to the head of the second T-shaped stopper.

7. The automatic tire inflation nozzle of claim 5, further comprising:
a third biasing member placed between the adjusting member and the second T-shaped stopper.

8. The automatic tire inflation nozzle of claim 5, wherein the adjusting member comprises:
an adjusting knob;
a lead screw provided on a first end of the adjusting knob; and
a square nut engaged with an outer surface of the lead screw.

9. The automatic tire inflation nozzle of claim 6, wherein the adjusting member comprises:
an adjusting knob;
a lead screw provided on a first end of the adjusting knob; and
a square nut engaged with an outer surface of the lead screw.

10. The automatic tire inflation nozzle of claim 8, further comprising:
a third biasing member placed between the square nut and the second T-shaped stopper.

11. An automatic tire inflation nozzle system, comprising:
an automatic tire inflation nozzle disclosed in claim 1;
a connection rod having a first end combined with the piston rod protruding outside the nozzle body unit; and
a tire contact part combined with a second end of the connection rod and being in contact with an inner surface of the tire.

12. The automatic tire inflation nozzle system of claim 11, further comprising:
a first biasing member placed between the connection rod and a lower end of the nozzle body unit.

13. An automatic tire inflation nozzle system, comprising:
an automatic tire inflation nozzle disclosed in claim 1;
a piston control rod having a first end combined with the piston rod protruding outside the nozzle body unit, the piston control rod being provided with a spring holding protrusion protruding horizontally outward;
a connection rod having a first end combined with a second end of the piston control rod;
a tire contact part combined with a second end of the connection rod and being in contact with an inner surface of the tire; and
a first biasing member placed between the piston control rod and a lower end of the nozzle body unit.
